(19) United States
(12) Patent Application Publication
(10) Pub. No.: US 2026/0013527 A1
(43) Pub. Date: Jan. 15, 2026

(54) LOW-LIPID PEA PROTEIN ISOLATE

(71) Applicant: ROQUETTE FRERES

(72) Inventor: Kerry CAMPBELL, Geneva, IL (US)

(21) Appl. No.: 18/880,961

(22) PCT Filed: Jul. 5, 2023
(86) PCT No.: PCT/EP2023/025312

§ 371 Date: Jan. 3, 2025

Related U.S. Application Data
(60) Provisional application No. 63/358,635, filed on Jul. 6, 2022.

(30) Foreign Application Priority Data
Jul. 20, 2022 (EP) 22306081.5

(51) Int. Cl. A23J 1/14; A23L 11/30

(52) U.S. Cl. CPC A23J 1/14; A23L 11/30

(57) ABSTRACT

The present invention relates to a leguminous plant protein isolate comprising at least 75% of protein and having a low content of total lipids below 6 g per 100 g of protein based on dry weight, to a process for producing said isolate and to uses thereof.

### TECHNICAL FIELD

The invention relates to the field of leguminous protein isolates, more particularly of pea protein isolates having a low lipid content.

### BACKGROUND ART

Human daily requirements for proteins are between 12 and 20% of food intake. These proteins are supplied both by products of animal origin (meat, fish, eggs, dairy products) and by products of plant origin (cereals, leguminous plants, algae).

However, in developed countries, protein intake is predominantly in the form of proteins of animal origin. And yet, numerous studies show that excessive consumption of proteins of animal origin to the detriment of plant proteins is one of the causes of increases in cancer and cardiovascular diseases.

Moreover, animal proteins have many disadvantages, both in terms of their allergenicity, regarding in particular proteins originating from milk or eggs, and in terms of the environment, in relation to the harm done by intensive farming.

Thus, there is an increasing demand from manufacturers for compounds of plant origin having beneficial nutritional and functional properties without, however, having the disadvantages of compounds of animal origin.

Nevertheless, replacing animal proteins by vegetable proteins is not always easy because their physical and chemical properties are different, and this has an impact on the sensory qualities of the foods in which these proteins are incorporated.

Since the 1970s, the development of pulse plants, in particular including pea, in Europe and mainly in France, has dramatically increased as an alternative protein resource to animal proteins for animal and human food consumption. The pea contains approximately 27% by weight of protein substances. The term “pea” is considered here in its broadest accepted use and includes, in particular, all the wild varieties of “smooth pea” and all the mutant varieties of “smooth pea” and “wrinkled pea”, regardless of the uses for which said varieties are usually intended (human food, animal feed and/or other uses). These seeds are non-GMOs unlike soy, and do not require a de-oiling step using solvents.

A disadvantage of some plant proteins, especially leguminous plant proteins, and more particularly pea proteins, is that they are not taste-free. They can therefore bring off-flavors to the foods in which they are incorporated. These tastes are frequently described by consumers as “beany”, pea-like or bitter.

A known solution to this problem is to mask these unpleasant flavors by introducing chemical compounds such as flavors during the manufacturing process.

Nevertheless, this solution is often not satisfactory because it does not allow to mask the unpleasant flavor but only to reduce it slightly. A second disadvantage is that the food manufacturing process is then more expensive due to the addition of extra ingredients. In addition, more and more consumers are turning away from products containing chemical compounds in favor of healthier food.

A more advantageous solution is to use directly a vegetable protein isolate with little or no unpleasant taste. Some examples of methods to obtain such isolates are already described. For example, WO2017/120597 describes a method for precipitation in the form of salts, combined with a specific washing of the proteins with a large volume of an aqueous solution at neutral pH.

As lipids are the substrates of lipoxygenase and oxidation reactions leading to the formation of volatile compounds responsible for off-flavors in leguminous plant protein, lipid extraction could be an efficient method to produce protein isolates devoid of these off-flavors and/or with a more stable flavor during storage, in particular due to the oxidation of residual lipids. Indeed, it is described in the literature (Sessa and Rackis J. A . . . . Oll Chemists'Soc 1979, 56, 262-271) that the main cause of the development of these off-flavors during harvesting, processing, and storage is the oxidation of unsaturated fatty acids, particularly linoleic and linolenic acids.

Lipid content can reflect two different kind of contents. One is the “extractable lipid” content which reflects refers to “free” lipid constituents that can be extracted into low polar solvents, such as light petroleum ether or diethyl ether. The other one is the “total lipid content” which reflects the whole content of lipids, extractable or not. As used herein, the lipid content is to be considered as “total lipid content”, as explained below in the description, and a method for determining such content can be found thereafter. In the case of proteins, these two lipid contents generally differ widely because of the bound lipids that are present in the protein. As shown below in the examples section of the description, commercial pea protein isolates generally comprise 10 to 12 g of lipids per 100 g of protein. Two recent samples of Pisane® C9 commercialized by Cosucra were analyzed by the Applicant as comprising around 11 g of total lipids per 100 g of protein and around 0.5 g of extractable lipid per 100 g of protein. US20080226811 A1 (equivalent to FR2889417 A1) discloses a pea protein composition comprising 84% of protein and extractable lipids content of 0.5%. As shown in the example section, the total lipid content of this pea protein is around 10 g total lipids per 100 g of protein.

The use of organic solvents for removing lipid from air classified pea proteins is already known. For example, Peter, R. describes the manufacture of alcohol washed protein concentrates with low lipid content in PROPERTIES OF AQUEOUS-ALCOHOL-WASHED PROTEIN CONCENTRATES PREPARED FROM AIR-CLASSIFIED PEA PROTEIN AND OTHER AIR-CLASSIFIED PULSE PROTEIN FRACTIONS, Saskatoon, SK: Department of Food and Bioproducts Sciences, University of Saskatchewan (2018). However, even after multiple alcohol washing steps, the protein content in the protein concentrates are still limited and do not exceed 75%. And because of denaturation due to the use of organic solvents, the functional properties of the protein concentrate is greatly modified: for example, the solubility of protein shows a strong decrease. Solubility is critical for use of protein in food applications, as soluble proteins provide homogenous dispersability in colloidal systems and enhance the interfacial properties. This is even more important when the compositions have an increased amount of protein in the pea protein isolate, e.g. to have a content of protein of 75% or above. Furthermore, these concentrates have very low particle size (d-90 lower than 10 μm). This is because the protein concentrates are made by fine milling followed by air classification: the finest fraction is the rich protein fraction. This fine particle size is not desirable and cause difficulties, mainly due to dust formation and explosion hazard. Furthermore, the use of organic solvents is detrimental for many reasons (ecological, costs, ease of use, difficulties to recycle in industrial facilities).

Legume protein isolate with decreased lipid content are also disclosed in WO2021/130446, according to a process that has the advantage of not using any organic solvent. However, even if the protein isolate of this document has a decreased lipid content, this lipid content can still be too important for certain uses.

It is therefore advantageous to obtain a leguminous plant protein isolate, more particularly a pea protein isolate that has a decreased lipid content. It is also an advantage to be able to provide such protein isolates with low lipid content without using organic solvents.

### GENERAL DESCRIPTION OF THE INVENTION

According to a first aspect of the invention, there is provided a leguminous plant protein isolate comprising at least 75% of protein based on the dry weight of the protein isolate, wherein the total lipid content of the leguminous plant protein is below 6 g per 100 g of protein, the quantities being expressed on dry matter basis.

In the present application, “dry matter” must be understood as the relative percentage by weight of solids based on total weight of the sample. Every well-known method can be used but desiccation method, which consists of estimating quantity of water by heating a known quantity of sample, is preferred. In the desiccation method:
a sample is prepared and its mass is weighed: m₁ (g),
sample is put in an oven, to volatize water, until stabilization of the sample's mass. Preferably, during this step, the temperature is 105° C. at common atmospheric pressure.
final sample is weighed: m₂ (g)

$$The dry matter is calculated according to the following equation Dry matter = ( {m}_{2} / {m}_{1} ) * 10 \; 0 .$$

The term “protein isolate” should be understood in the present application as a composition having a protein content greater than 75%, preferably greater than 80%, even more preferably greater than 85%, this percentage being applied to the dry matter of said composition. The protein content is calculated using any methodology well known to a person skilled in the art. In particular, a total nitrogen dosage is carried out and is then multiplied by the coefficient 6.25. One method is indicated in the examples section. The said composition therefore comprises proteins, macromolecules formed by one or more polypeptide chains consisting of the chain of amino acid residues linked together by peptide bonds. In the particular case of pea proteins, the present invention more particularly relates to globulins (about 50-60% of the pea proteins). The protein isolate of the invention generally comprises at least 90% of globulins based on its protein content, preferentially at least 95%, more preferentially at least 97%. The presence of protein fractions (globulin, albumins . . . ) can be qualitatively observed by using SDS-PAGE method. Globulins and albumins are differentiated by a different solubility at pH 5. The protein isolate of the invention generally have a solubility at pH 5 below 20%, for example below 15%. Globulins and albumins can also be differentiated by their different amino acids contents and these contents will depend on the botanical source. The protein isolates of the invention can be obtained by isoelectric precipitation. Generally, protein isolates obtained by isoelectric precipitation have the pH 5 solubility above.

For the purposes of the present invention, the term “leguminous plants” means any plants belonging to the family Cesalpiniaceae, the family Mimosaceae or the family Papilionaceae, and in particular any plants belonging to the family Papilionaceae. It can be for instance pea, fava bean, mung bean, lentil, alfalfa, soybean or lupin bean. Preferably, said leguminous plant is chosen from the group consisting of pea, fava bean, chickpea and mung bean. Even more preferably, said leguminous plant is pea. In a preferred embodiment, said leguminous plant is soybean.

According to the invention, the term “pea” is herein considered in its broadest accepted sense and includes in particular:
all varieties of “smooth pea” and of “wrinkled pea”, and
all mutant varieties of “smooth pea” and of “wrinkled pea”, this being whatever the uses for which said varieties are generally intended (food for human consumption, animal feed and/or other uses).

In the present application, the term “pea” includes the varieties of pea belonging to the Pisum genus and more particularly Pisum sativum.

Said mutant varieties are in particular those known as “r mutants”, “rb mutants”, “rug 3 mutants”, “rug 4 mutants”, “rug 5 mutants” and “lam mutants” as described in the article by C-L HEYDLEY et al. entitled “Developing novel pea starches”, Proceedings of the Symposium of the Industrial Biochemistry and Biotechnology Group of the Biochemical Society, 1996, pp. 77-87.

In a preferred embodiment, the pea is derived from smooth pea, in particular yellow smooth pea.

The term “total lipids” in the present application is defined as the whole lipid molecules without distinction. They thus comprise triglycerides, phospholipids, free fatty acids. The lipid assay can be carried out by acid hydrolysis, followed by hexane extraction and a specific dosage. A method is disclosed in the Examples section.

According to one aspect of the present invention, the total lipid content of the leguminous plant protein is comprised between 0.5 to 5 g per 100 g of protein, for example between 1 and 4.5 g per 100 g of protein.

According to one aspect of the invention, the protein isolate is free of organic solvent.

By “a composition that does not contain traces of organic solvent” it is meant a composition that contains less than 100 ppm of solvent, preferably less than 10 ppm of organic solvent and more preferably a composition that does not contain organic solvent at all.

By “organic solvent”, it is meant solvent based on compounds that contain carbon. On the opposite, inorganic solvents which are allowed in this invention do not contain carbon. A typical inorganic solvent allowed in the present invention is water.

According to one aspect of the invention, the leguminous plant protein isolate has a starch content below 3% by weight, based on the weight of dry matter, advantageously below 2%, preferably below 1.5%, even more preferably below 1%.

According to another aspect of the invention, the leguminous plant protein isolate comprises residual starch. The protein isolate can have a starch content of at least 0.3%, advantageously at least 0.5%, preferably at least 0.8%.

In one embodiment, the starch content is comprised between 0.3 and 3%, preferably between 0.5% and 2%, even more preferably between 0.5 and 1.5%.

Starch content of the composition can be determined using AOAC Official Method 996.11, Starch (Total) in Cereal Products.

According to one aspect of the present invention, the protein isolate has a solubility at pH 7 of 50% or more, preferably 60% or more, even more preferably 65% or more.

Solubility is defined as the content of soluble matter of the composition based on the total dry matter of the protein isolate when determined at pH 7, generally at 20° C. This solubility, also referred as “total solubility”, can be determined by any known accurate method. This solubility differs from the Nitrogen Solubility Index (NSI) in that only the nitrogen is considered in the NSI method. Depending on whether protein isolate is in a solid or liquid form, solubility can be determined in a different manner. A method for both solid and liquid are indicated in the examples section.

According to one aspect of the present invention, the protein isolate has emulsion capacity of at least 300 mL per g of protein, preferably at least 400 mL per g of protein, more preferably at least 550 mL per g, even more preferably at least 650 mL per g. The protein isolate has generally an emulsion capacity below 1000 mL per g of protein, for example below 900 mL per g.

Emulsion capacity is defined as the maximum amount of oil that can be dispersed in an aqueous solution containing a defined amount of emulsifier before breaking or phase inversion of the emulsion. Different methods can be used to determine the emulsion capacity and give similar results. A detailed method to determine this feature of the invention is indicated in the Examples section. Another method giving similar results is a test consisting of carrying out the following steps:
1. 0.2 g of the product sample is dispersed in 20 ml of water.
2. The solution is homogenized with an Ultraturax IKA T25 device for 30 sec at a speed of 9500 revolutions per minute (rpm).
3. Addition of 20 ml of corn oil, for example the one sold under the name Amphora by the company Cargill, under homogenization under the same conditions as the previous step 2.
4. Centrifugation for 5 minutes at 3100 g.
a. If a good emulsion is obtained, that is to say without breaking or phase inversion of the emulsion, the test is started again from step 1 with the amounts of water and corn oil being increased by 50%.
b. If a bad emulsion is obtained, for example phase separation, breaking or phase inversion of the emulsion, the test is started again from step 1 with the amounts of water and corn oil being decreased by 50%.
The maximum amount of oil (Qmax in ml) that can be emulsified is thus determined iteratively. The emulsifying capacity is therefore the maximum amount of corn oil that can be emulsified per gram of product. Emulsifying capacity=(Qmax/0.2)×100

According to one aspect of the present invention, the protein isolate is in a powder form having a d-90 of 20 μm or higher, preferably 200 μm or higher.

In the present application “particle size” must be understood as a notion introduced for comparing dimensions of solid, liquid or gaseous particles. The particle-size distribution (PSD) of a powder, or granular material, or particles dispersed in fluid, is a list of values or a mathematical function that defines the relative amount, typically by mass, of particles present according to size. Several methods can be used for measuring particle size and particle size distribution. Some of them are based on light, or on ultrasound, or electric field, or gravity, or centrifugation. The use of sieves is a common measurement technique. In the present application, the use of laser diffraction method is preferred. The man skilled in the art will be able to select a laser diffraction method allowing him to obtain an accurate particle size determination. An example of such method is indicated in the examples section. As for the value “d_90” this is the particle size for which 90% of the particles (volume-weighted) are below this value.

In another aspect, the present invention relates to process for producing the leguminous plant protein isolate described above.

In particular, the present invention relates to a process comprising the steps of:
a. preparing a protein-rich water suspension from leguminous plant starting material;
b. separating a soluble fraction comprising protein from an insoluble fraction comprising starch and fibers;
c. adding a surfactant to the soluble fraction to form surfactant-containing soluble fraction;
d. heating the surfactant-containing soluble fraction;
e. forming a leguminous plant proteic precipitate in the soluble fraction;
f. separation of the leguminous plant proteic precipitate from soluble components to obtain a protein curd;
g. Optionally a step of washing of the protein curd;
h. Optionally a step of adjusting the pH of the protein curd at a range going from 6.5 to 8.0;
i. Optionally a step of heat treatment of the protein curd;
j. Optionally a step of homogenization treatment;
k. Optionally a step of drying.

In one embodiment, the leguminous plant starting material can be flour of dehulled leguminous plant, which is suspended in water. Said suspension of flour can be obtained by dry grinding or wet grinding of the leguminous plant. In another embodiment, the leguminous plant starting material is a protein concentrate from leguminous plant. Generally, the leguminous plant starting material was not subjected to any organic solvent extraction before use.

The process of the present invention comprises a step b), which consists in separating a soluble fraction comprising protein from an insoluble fraction comprising starch and fibers. This step can be performed using separation devices such as hydrocyclones, a decanter, a disc centrifuge, a tubular centrifuge, a basket centrifuge or a rotary vacuum filter combination thereof.

In one aspect of the invention, no enzyme is added to the protein-rich water suspension prior to the separation step b). In particular, in one embodiment of the invention, no amylase is used.

During step c), a surfactant is added to the soluble fraction, to form a surfactant-containing soluble fraction.

The surfactant can be a non-ionic surfactant even more preferably a ethoxylated sorbitan esterified with fatty acids, such as polyoxyethylene sorbitan monooleate (polysorbate).

Typically, the surfactant can be a polysorbate. Polysorbates are a class of emulsifiers used in cosmetic, pharmaceuticals and food preparations. Polysorbates are oily liquids derived from ethoxylated sorbitan (a derivative of sorbitol) esterified with fatty acids. Common brand names for polysorbates include Scattics, Alkest, Canarcel, and Tween. Common used polysorbate are Polysorbate 20 (polyoxyethylene (20) sorbitan monolaurate), Polysorbate 40 (polyoxyethylene (20) sorbitan monopalmitate), Polysorbate 60 (polyoxyethylene (20) sorbitan monostearate) and Polysorbate 80 (polyoxyethylene (20) sorbitan monooleate) (number following ‘polyoxyethylene’ refers to total number of oxyethylene —(CH2CH₂O)— groups found in the molecule and number following ‘polysorbate’ is related to the type of fatty acid associated with the polyoxyethylene sorbitan part of the molecule). Preferably, the polysorbate is Polysorbate 80 (polyoxyethylene (20) sorbitan monooleate) also known as Tween 80.

According to one embodiment, the total mass content of surfactant added in step c) is between 0.1 and 10%, based on the total mass of dry matter of the leguminous protein material of step a, preferably between 0.5 and 4%.

The surfactant-containing soluble fraction of step c) is then heated during step d).

Typically, the temperature of the additive-containing soluble fraction during step d) is between 30 and 90° C., preferably between 5° and 80° C.

Typically, step d) is carried out between 5 and 150 minutes, for example between 15 and 120 minutes and preferably between 20 and 40 minutes.

In one embodiment, the pH of the additive-containing soluble fraction is comprised between 4 and 8.

The process comprises a step e) of forming a protein precipitate. This step is carried out by adjusting the pH of the heated additive-containing soluble fraction between 4.2 and 5.8, preferably between 4.5 and 5.4. This corresponds to the isoelectric point of the proteins and allows the proteins to precipitate. This step e) can be carried out at a temperature going from 20 to 90° C., for example between 60 to 85° C. This step e) can be carried out for a duration between a few seconds and 150 minutes, for example between few seconds and 30 minutes.

In a particular embodiment, steps d) and e) can be performed simultaneously. In this case, these steps d) and e) should preferably be carried out between 5 and 150 minutes, for example between 15 and 120 minutes and preferably between 20 and 40 minutes.

Alternatively, steps e) and d) can be carried out in a different order. Typically, the pH of the surfactant-containing soluble fraction can be adjusted to the isolectric pH (typically, around 4.9) prior to the heat treatment step.

Once the protein precipitate has been formed, it is collected during step f). This separation step f) can be done using a membrane such as a polymeric, ceramic or metal membrane, a decanter, a disc centrifuge, a tubular centrifuge, a basket centrifuge or a rotary vacuum filter.

The process of the invention can comprise further optional steps, such as a washing step, a pH adjustment step (to a pH between 6.5 and 8), a heat treatment step, a homogenizing step and/or a drying step.

These steps can be carried out by any suitable method, known to the skilled person in the art.

Alternatively, the surfactant may be added to the leguminous plant proteic precipitate in the soluble fraction before separation to obtain a protein curd.

Thus, the invention also concerns a process of preparing a protein-rich water suspension from leguminous plant starting material comprising:
a) separating a soluble fraction comprising protein from an insoluble fraction comprising starch and fibers;
b) forming a leguminous plant proteic precipitate in the soluble fraction;
c) heating the surfactant-containing soluble fraction;
d) adding a surfactant to the leguminous plant proteic precipitate in the soluble fraction;
e) separation of the leguminous plant proteic precipitate from soluble components to obtain a protein curd;
f) Optionally a step of washing of the protein curd;
g) Optionally a step of adjusting the pH of the protein curd, for example at a range going from 6.5 to 8.0;
h) Optionally a step of heat treatment of the protein curd;
i) Optionally a step of homogenization treatment;
j) Optionally a step of drying.

The total mass content of surfactant added and the conditions of heating the surfactant-containing soluble fraction can be done in the same way than for the process previously disclosed. The forming of a leguminous plant proteic precipitate in the soluble fraction can also be done using the same adjustment of pH, eventually in combination with a heating step.

In one embodiment, the leguminous plant protein is a non-hydrolyzed protein.

The process of the invention can comprise any enzymatic treatment step using proteases after the treatment step of the leguminous plant protein. Endoproteases are enzymes which can reduce significantly the weight average molecular weight of large amino acids because the hydrolysis takes place inside the amino acids chains. Exoproteases are enzymes which can less reduce the weight average molecular weight of large amino acids because the hydrolysis takes place at the end of the amino acids chains.

Enzymes are generally classified using the Enzyme Commission number (EC number), which is a numerical classification scheme for enzymes, based on the chemical reactions they catalyze. Main classes of enzymes able to hydrolyze proteins are protease and hydrolases acting in linear amides on carbon-nitrogen bonds other than peptide bonds. Proteases are classified according to this classification under the EC number 3.4. Hydrolases acting in linear amides on carbon-nitrogen bonds other than peptide bonds are classified according to this classification under the EC number 3.5.1. These hydrolase enzymes EC 3.5.1 encompass for example glutaminase.

In an embodiment, the process of the invention comprises an enzymatic step using an enzyme able to hydrolyze proteins different from endoprotease, advantageously using hydrolases of EC 3.5.1, for example using glutaminase. In a preferred mode of this embodiment, the enzymatic step is applied on the leguminous plant protein.

However, it is not needed to use enzymes in the process of the invention. In an embodiment, the process of the invention does not comprise any enzymatic treatment step using protease after the treatment step of the leguminous plant protein. In an embodiment, the process of the invention does not comprise any enzymatic treatment step using glutaminase after the treatment step of the leguminous plant protein. In an embodiment, the process of the invention does not comprise any enzymatic treatment step using hydrolases of EC 3.5.1 after the treatment step of the leguminous plant protein. In an embodiment, the process does not comprise any enzymatic treatment step using endoprotease. In an embodiment, the process of the invention does not comprise any enzymatic treatment step using protease. In an embodiment, the process of the invention does not comprise any enzymatic treatment step using glutaminase.

In an embodiment, the process of the invention does not comprise any enzymatic treatment step using hydrolases of EC 3.5.1. Each of the embodiments regarding the use of enzymes described in this paragraph can of course be combined.

When the process comprises a drying step k), said drying step can be a spray drying step. Said drying step and especially spray drying step can be implemented by the skilled person in order to obtain the powder of protein isolate of the invention, this powder having the desired particle size.

In general terms, the leguminous plant protein isolate of the invention can be used in food and beverage products that may include the leguminous plant protein isolate in an amount of up to 100% by weight relative to the total dry weight of the food or beverage product, for example in an amount of from around 1% by weight to around 80% by weight relative to the total dry weight of the food or beverage product. All intermediate amounts (i.e. 2%, 3%, 4% . . . 77%, 78%, 79% by weight relative to the total weight of the food or beverage product) are contemplated, as are all intermediate ranges based on these amounts. Food or beverage products which may be contemplated in the context of the present invention include baked goods; sweet bakery products (including, but not limited to, rolls, cakes, pies, pastries, and cookies); pre-made sweet bakery mixes for preparing sweet bakery products; pie fillings and other sweet fillings (including, but not limited to, fruit pie fillings and nut pie fillings such as pecan pie filling, as well as fillings for cookies, cakes, pastries, confectionary products and the like, such as fat-based cream fillings); desserts, gelatins and puddings; frozen desserts (including, but not limited to, frozen dairy desserts such as ice cream-including regular ice cream, soft serve ice cream and all other types of ice cream—and frozen non-dairy desserts such as non-dairy ice cream, sorbet and the like); carbonated beverages (including, but not limited to, soft carbonated beverages); non-carbonated beverages (including, but not limited to, soft non-carbonated beverages such as flavored waters, fruit juice and sweet tea or coffee based beverages); beverage concentrates (including, but not limited to, liquid concentrates and syrups as well as non-liquid ‘concentrates’, such as freeze-dried and/or powder preparations); yogurts (including, but not limited to, full fat, reduced fat and fat-free dairy yogurts, as well non-dairy and lactose-free yogurts and frozen equivalents of all of these); snack bars (including, but not limited to, cereal, nut, seed and/or fruit bars); bread products (including, but not limited to, leavened and unleavened breads, yeasted and unyeasted breads such as soda breads, breads comprising any type of wheat flour, breads comprising any type of non-wheat flour (such as potato, rice and rye flours), gluten-free breads); pre-made bread mixes for preparing bread products; sauces, syrups and dressings; sweet spreads (including, but not limited to, jellies, jams, butters, nut spreads and other spreadable preserves, conserves and the like); confectionary products (including, but not limited to, jelly candies, soft candies, hard candies, chocolates and gums); sweetened and un sweetened breakfast cereals (including, but not limited to extruded breakfast cereals, flaked breakfast cereals and puffed breakfast cereals); and cereal coating compositions for use in preparing sweetened breakfast cereals. Other types of food and beverage product not mentioned here but which conventionally include one or more nutritive sweetener may also be contemplated in the context of the present invention. In particular, animal foods (such as pet foods) are explicitly contemplated. It can also be used, eventually after texturization by extrusion, in meat-like products such as emulsified sausages or plant-based burgers. It can also be used in egg replacement formulations.

The food or beverage product can be used in specialized nutrition, for specific populations, for example for baby or infants, elderly people, athletes, or in clinical nutrition (for example tube feeding or enteral nutrition).

The leguminous plant protein isolate can be used as the sole source of protein but also can be used in combination with other plant or animal proteins. The term “plant protein” denotes all the proteins derived from cereals, oleaginous plants, leguminous plants and tuberous plants, and also all the proteins derived from algae and microalgae or fungi, used alone or as a mixture, chosen from the same family or from different families. In the present application, the term “cereals” is intended to mean cultivated plants of the grass family producing edible grains, for instance wheat, oat, rye, barley, maize, sorghum or rice. The cereals are often milled in the form of flour, but are also provided in the form of grains and sometimes in whole-plant form (fodders). In the present application, the term “tubers” is intended to mean all the storage organs, which are generally underground, which ensure the survival of the plants during the winter season and often their multiplication via the vegetative process. These organs are bulbous owing to the accumulation of storage substances. The organs transformed into tubers can be the root e.g. carrot, parsnip, cassava, konjac), the rhizome (e.g. potato, Jerusalem artichoke, Japanese artichoke, sweet potato), the base of the stalk (more specifically the hypocotyl, e.g. kohlrabi, celeriac), the root and hypocotyl combination (e.g. beetroot, radish). The animal protein can be for example egg or milk proteins, such as whey proteins, casein proteins or caseinate. The leguminous plant protein isolate can thus be used in combination with one or more of these proteins or amino acids in order to improve the nutritional properties of the final product, for example to improve the PDCAAS of the protein or to bring other or modify functionalities. The food or beverage product can be acid-gelling food products, such as yogurts, cheeses or acidic sauces.

Advantageously, in one aspect of the invention, the starch and/or the fiber fractions are also recovered during step b). In this way, these “by-products” are also recovered and can be further processed in order to be used for other applications, such as applications in the food and/or feed industry.

### EXAMPLES

### Example 1: Low Lipid Pea Protein Isolate from Pea Flour, Benchtop Scale

The following protocol was followed: Weigh 4 kg pea flour into 18 L of water at 50° C. in a 30 L tank. Agitate for 10 minutes with an overhead agitator. Centrifuge in a Lemitec decanter centrifuge, 5500 rpm bowl speed, 20 rpm differential speed, 60 mm weir diameter, 1000 ml/min feed rate. Collect the light phase. Place 1 L of the light phase in a 2000 ml metal beaker and adjust at a pH of 5.5. Heat on a hot plate to 60° C., add 4.7 g polysorbate 80 (equivalent to 1.75% based on the total mass of dry matter of the flour), agitate for 10 minutes. Pass through homogenizer at 400 bar primary pressure, 40 bar secondary pressure. Adjust pH to 4.9 and centrifuge in 1 L bottles in swinging bucket rotor in Sorval centrifuge at 3000×g for 5 minutes. Dry resulting pellet overnight at 90° C. in a convection oven.

The composition of the pea protein isolate was analyzed and the pea protein isolate had a protein content of 88.2% based on the dry weight of the protein isolate and 2.6 g of lipids per 100 g of protein, the quantities being expressed on dry matter basis.

### Example 2: Low Lipid Pea Protein Isolate from Pea Flour, Pilot Scale

The following protocol was followed: Add 200 L water and 45 kg pea flour to a 400 L tank. Agitate for 10 minutes. Feed slurry to Flottweg Z2 decanter centrifuge at 5 gpm, 3000 rpm bowl speed. Collect the light phase in a 400 L jacketed tank. Heat the light phase to 60° C. with hot water on the tank jacket, then add 1.3 kg of polysorbate 80 and agitate for 30 minutes. Adjust the pH to 4.9 with hydrochloric acid 3N, maintain at 60° C., and hold around 10 minutes, then feed to Flottweg Z2 decanter at 2.5 gpm, 5000 rpm bowl speed. Collect the heavy phase. Dilute the heavy phase to 12% total solids, adjust pH to 7.0 with sodium hydroxide solution (3N), heat with direct steam injection to 140° C., hold 10 s, flash cool to 60° C., homogenize (200 bar primary, 20 bar secondary) and spray dry (inlet temperature 210° C., outlet temperature 90° C.).

### Example 3: Control Pea Protein Isolate from Pea Flour, Pilot Scale

The following protocol was followed: Add 200 L water and 45 kg pea flour to a 400 L tank. Agitate for 10 minutes. Feed slurry to Flottweg Z2 decanter centrifuge at 5 gpm, 3000 rpm bowl speed. Collect the light phase in a 400 L jacketed tank. Adjust the pH to 4.9 with hydrochloric acid solution (3N), heat to 60° C., hold around 10 min, then feed to Flottweg Z2 decanter at 2.5 gpm, 5000 rpm bowl speed. Collect the heavy phase. Dilute the heavy phase to 12% total solids, adjust pH to 7.0 with sodium hydroxide solution (3N), heat with direct steam injection to 140° C., hold 10 s, flash cool to 60° C., homogenize (200 bar primary, 20 bar secondary) and spray dry (inlet temperature 210° C., outlet temperature 90° C.).

The composition and properties of pea protein isolates from example 2 and 3 are reported in the Table 1 below.

Samples of pea protein isolates from different manufacturers were also analyzed for thir composition (protein and lipid contents) and the average of the results obtained are reported in Table 2.

### Example 4: Low Lipid Pea Protein Isolate from Pea Flour, Pilot Scale

The following protocol was followed: Add 300 L water and 68 kg pea flour to a 400 L tank. Agitate for 10 minutes. Feed slurry to Flottweg Z2 decanter centrifuge at 5 gpm, 3000 rpm bowl speed. Collect the light phase in a 400 L jacketed tank. Adjust the pH to 4.9 with hydrochloric acid 3N. Heat the light phase to 60° C. with hot water on the tank jacket. Then add 2 kg of polysorbate 80 and agitate for 60 minutes and maintain at 60° C., then feed to Flottweg Z2 decanter at 5 gpm, 5000 rpm bowl speed. Collect the heavy phase. Dilute the heavy phase to 13% total solids, adjust pH to 7.0 with sodium hydroxide solution (3N), heat with direct steam injection to 150° C., hold 15 s, flash cool to 60° C., and spray dry (inlet temperature 220° C., outlet temperature 80° C.).

### Example 5: Comparative Pea Protein Isolate

As a comparative pea protein isolate, a sample of granulated pea protein as claimed in US20080226811 A1 (NUTRALYS® F85G) was analyzed and reported in the Table below.

### Example 6: Comparative Pea Protein Isolates

As comparative pea protein isolates, two samples (6 and 6′) of pea protein isolates commercialized by COSUCRA (PISANE® C9) were analyzed and reported in the Table below. For these two samples, the extractable lipid contents were determined as having around 0.5 g extractable lipids per 100 g of proteins. As shown in the Table below, the total lipid content is much higher

TABLE 1
Pea protein isolates composition and functional properties of Example 2 and 3

| | | g total | | | | | | | | | | |
|---|---|---|---|---|---|---|---|---|---|---|---|---|
| | | lipid/ | | | | | | | Emulsion | | | |
| | % | 100 g | % | % | Hexanal | Solubility | NSI | d-90 | capacity | | | |
| Example | Protein | protein | fiber | starch | (ppb) | (%) | (%) | (μm) | (mL oil/g) | L* | a* | b* |
| 2 | 86.4% | 1.9 | 6.9% | 1.3% | 3430 | 59 | 69 | 26 | 575 | 87 | 3 | 20 |
| 3 | 85.0% | 6.9 | 5.8% | 1.2% | 11900 | 74 | 87 | 25 | 200 | 89 | 2 | 23 |
| 4 | 89.3% | 4.8 | 2.7% | 1.7% | 4150 | 66 | nd | nd | 850 | 89 | 1 | 16 |
| 5 | 85% | 10 | nd | nd | nd | 33 | nd | nd | 325 | nd | nd | nd |
| 6 | 87.7% | 10.6 | nd | nd | nd | | nd | nd | 300 | nd | nd | nd |
| 6′ | 84.2% | 11 | nd | nd | nd | | nd | nd | 250 | nd | nd | nd |

The proteins have solubility at pH 5 lower than 20% (a solubility at pH 5 of 14% was measured for sample 4). A visual observation of the proteins also shows that the proteins of the invention (2, 4) had also a more appealing color than the one of the control (3) (less yellow and green), and this was reflected by a smaller b* value (and a slightly higher a* value in the case of sample 2).

A sensory analysis of the samples 3 (control) and 4 (invention) was also made using the method detailed below. The sensory results showed that suspensions made from proteins of the invention had much less pea flavor. They also tended to have a lower overall aromatic intensity compared to that of control pea protein isolate.

TABLE 2
Other commercial pea protein isolates

| Commercial protein | | g lipid/100 g |
|---|---|---|
| isolates | % Protein | protein |
| Cosucra | 85.3% | 10.5 |
| NutriPea | 83.4% | 10.9 |
| Jianyuan | 81.5% | 11.3 |
| Oriental | 82.1% | 10.7 |
| Shuangta | 86.3% | 10.9 |

### Example 7: Analytical Methods

protein content: Protein content is % N6.25 and nitrogen content is determined using combustion analyzer-Elementer, with AOAC 997.09 method.

lipid content: total lipid content is determined using AOAC 996.06 method. The quantity of lipids in g/100 g per protein is calculated based on the lipid and protein contents.

Starch content: AOAC Official Method 996.11.

% fiber: AOAC official method 2017.16.

Color L*a*b*: Determined using a device CR-5 from Konica Minolta following the instructions manual.

d 90 (μm): d 90 is measured by a laser granulometry apparatus (Mastersizer 3000, from Malvern), which measures intensity of scattered light across a range of scattering angles using forward scattering measurement, on a dry powder without dispersion buffer, and using the software of the apparatus with the Mie scattering model to fit the distribution to the measured scattering pattern.

Hexanal content is determined using gas chromatography. Such method is described for example by Ha et al. in Analytical Sciences, 2011, Vol. 27 pages 873-878 “Determination of Hexanal as an Oxidative Marker in Vegetable Oils Using an Automated Dynamic Headspace Sampler Coupled to a Gas Chromatograph/Mass Spectrometer.

A Difference From Control (DFC) test was conducted using 13 panelists and three samples: the control, a blind control and the invention sample. Products were prepared in suspension of 4% of powder in water. The session occurred in a quiet room with white light. Panelists had blinded samples, presented in a randomized order, and tested at room temperature.

Nitrogen Solubility Index: A portion of sample is suspended in water with stirring at 30° C. for two hours. It is then diluted to a known volume with water. A portion of sample extract is centrifuged and a aliquot analyzed for protein. A separate portion of sample is analyzed for total protein by the same method.

Emulsifying capacity determined using a test consisting of carrying out the following steps:
1. 0.2 g of the product sample is dispersed in 20 ml of water.
2. put 20 ml water, let hydrate during 30 minutes and adjust the pH using 1N HCl or NaOH to pH7.
3. Addition of 20 ml of soybean oil under homogenization with an Ultraturax IKA T25 device for 60 sec at a speed of 10000 revolutions per minute (rpm).
4. Centrifugation for 5 minutes at 3200 g.
a. If a good emulsion is obtained, that is to say without breaking or phase inversion of the emulsion, the test is started again from step 1 with the amounts of water and soybean oil being increased by 5 mL each.
b. If a bad emulsion is obtained, for example phase separation, breaking or phase inversion of the emulsion, the test is started again from step 1 with the amounts of water and soybean oil being decreased by 5 mL each.

The maximum amount of oil (Qmax in ml) that can be emulsified is thus determined iteratively.

The emulsifying capacity is therefore the maximum amount of soybean oil that can be emulsified per gram of product.

$$Emulsifying capacity = ( Qmax / 0.2 ) \times 100$$

### Solubility at pH7 (Powder Sample Method):

Pre-heat the oven to 130° C. Get the weight of the 100 ml beaker and small stir bar, then add 1.25 g of the protein powder to it, all while using the analytical balance. Record the total weight of beaker, stir bar and protein powder. Add about 35.00 g of de-ionized water (RT, 20±2° C.) and stir sample until the sample is completely dissolved. The stir plate is usually set at around 400 rpm. Adjust the pH of the solution with either 1N HCl or NaOH to reach the targeted pH of 7. Once pH is adjusted, add enough water to bring the total volume up to 50 g, then record the total weight of the sample, beaker, and water. Stir the sample for 30 minutes at around 700 rpm. Transfer the sample to a 50 mL centrifuge tube. Centrifuge the sample at 3.000×g for 15 minutes. Transfer the supernatant to a beaker and stir the sample to insure the supernatant is homogenized. Get the weight of a small aluminum pan and add about 15 g of the supernatant. Record the total weight. Place the samples in the oven for 75 minutes or until completely dry. Once dried, place the samples in the desiccator for 30 minutes to cool off and record the weight of the pan and dried sample.

### Solubility at pH5 (Powder Sample Method):

Pre-heat the oven to 130° C. Get the weight of the 100 ml beaker and small stir bar, then add 1.25 g of the protein powder to it, all while using the analytical balance. Record the total weight of beaker, stir bar and protein powder. Add about 35.00 g of de-ionized water (RT, 20±2° C.) and stir sample until the sample is completely dissolved. The stir plate is usually set at around 400 rpm. Adjust the pH of the solution with either 1N HCl or NaOH to reach the targeted pH of 5. Once pH is adjusted, add enough water to bring the total volume up to 50 g, then record the total weight of the sample, beaker, and water. Stir the sample for 30 minutes at around 700 rpm. Transfer the sample to a 50 mL centrifuge tube. Centrifuge the sample at 3.000×g for 15 minutes. Transfer the supernatant to a beaker and stir the sample to insure the supernatant is homogenized. Get the weight of a small aluminum pan and add about 15 g of the supernatant. Record the total weight. Place the samples in the oven for 75 minutes or until completely dry. Once dried, place the samples in the desiccator for 30 minutes to cool off and record the weight of the pan and dried sample.

### Solubility at pH7 (Liquid Sample Method):

Pre-heat the oven to 130° C. Get the solid content of the liquid sample and dilute the sample to 2.50% solid (with deionized water) and a total sample weight of 60 mL. This would be done for every desirable pH. Adjust to the desired pH with either 1N HCl or NaOH to reach the targeted pH of 7. Stir the sample for 30 minutes at around 700 rpm on the stir plate. Take the weight of two small aluminum pans on the analytical scale. After 30 minutes of stirring, transfer about 40 mL of the sample into a 50 mL centrifuge tube, transfer the rest to one of the aluminum dishes. Centrifuge the sample at 3.000×g for 15 minutes. Transfer the supernatant to a beaker and stir the sample to insure the supernatant is homogenized. Add about 15 g of the supernatant to the other pan. Record the total weight. Place both pans in the oven for 75 minutes or until the sample is completely dried. Once dried, place the samples in the desiccator for 30 minutes to cool off and record the weight of the pan and dried sample.

1. A leguminous plant protein isolate comprising at least 75% of protein based on the dry weight of the protein isolate, wherein the total lipid content of the leguminous plant protein is below 6 g per 100 g of protein, the quantities being expressed on dry matter basis.

2. The protein isolate of claim 1 wherein the total lipid content of the leguminous plant protein is 0.5 to 5 g per 100 g of protein, for example 1 to 4.5 g per 100 g of protein.

3. The protein isolate of claim 12 wherein the protein isolate is free of organic solvent.

4. The protein isolate of claim 1, wherein the starch content is below 3%, advantageously below 2%, preferably below 1.5%, even more preferably below 1%.

5. The protein isolate of claim 1 wherein the protein isolate comprises residual starch, for example wherein the starch content is at least 0.3%, advantageously at least 0.5%, preferably at least 0.8%.

6. The protein isolate of claim 1 wherein the solubility at pH 7 is 50% or more, preferably 60% or more.

7. The protein isolate of claim 1 wherein the emulsion capacity is 300 mL per g of protein or more, preferably 400 mL per g of protein or more.

8. The protein isolate of claim 1 wherein the leguminous plant is chosen from pea, fava bean and chickpea, preferably pea.

9. The protein isolate of claim 1 wherein the protein isolate is in a powder form having a d-90 of 20 μm or higher, preferably 200 μm or higher.

10. The protein isolate of claim 1 wherein the protein isolate comprises at least 80% of protein based on the dry weight of the protein isolate, preferably at least 85%.

11. A process for producing the leguminous plant protein isolate of claim 1 wherein the process comprises the steps of:
a. preparing a protein-rich water suspension from leguminous plant starting material;
b. separating a soluble fraction comprising protein from an insoluble fraction comprising starch and fibers;
c. adding a surfactant to the soluble fraction to form surfactant-containing soluble fraction;
d. heating the surfactant-containing soluble fraction;
e. forming a leguminous plant proteic precipitate in the soluble fraction;
f. separation of the leguminous plant proteic precipitate from soluble components to obtain a protein curd;
g. optionally a step of washing of the protein curd;
h. optionally a step of adjusting the pH of the protein curd, for example at a range going from 6.5 to 8.0;
i. optionally a step of heat treatment of the protein curd;
j. optionally a step of homogenization treatment; and,
k. optionally a step of drying.

12. The process of claim 11 wherein the total mass content of surfactant added in step c) is between 0.1 and 10%, based on the total mass of dry matter of the leguminous protein material of step a, preferably between 0.5 and 4%.

13. The process of claim 11 wherein the temperature of the additive-containing soluble fraction during step d) is between 30 and 90° C., preferably between 5° and 80° C.

14. The process of claim 11 wherein the step d) of heating the additive-containing soluble fraction is between 5 and 150 minutes, for example between 15 and 120 minutes and preferably between 20 and 40 minutes.

15. The process of claim 11 wherein the additive-containing soluble fraction has a pH between 4 and 8.

16. The process of claim 11 wherein the step e) of forming a protein precipitate is done by adjusting the pH of the heated additive-containing soluble fraction between 4.2 and 5.8, preferably between 4.5 and 5.4.

17. The process of claim 11 wherein the surfactant is a non-ionic surfactant, more preferably a ethoxylated sorbitan esterified with fatty acids, such as polyoxyethylene sorbitan monooleate.

18-19. (canceled)

20. The process of claim 11 wherein it comprises a drying step k), said drying step consisting in a spray drying step.

21. The process of claim 11 wherein steps d) and e) are simultaneous.

22. (canceled)

23. A process for producing the leguminous plant protein isolate of claim 1 wherein the process comprises the steps of:
a. preparing a protein-rich water suspension from leguminous plant starting material;
b. separating a soluble fraction comprising protein from an insoluble fraction comprising starch and fibers;
c. forming a leguminous plant proteic precipitate in the soluble fraction;
d. heating the surfactant-containing soluble fraction;
e. adding a surfactant to the leguminous plant proteic precipitate in the soluble fraction;
f. separation of the leguminous plant proteic precipitate from soluble components to obtain a protein curd;
g. optionally a step of washing of the protein curd;
h. optionally a step of adjusting the pH of the protein curd at a range going from 6.5 to 8.0;
i. optionally a step of heat treatment of the protein curd;
j. optionally a step of homogenization treatment; and,
k. optionally a step of drying.
